(19) United States
(12) Patent Application Publication
(10) Pub. No.: US 2024/0159998 A1
(43) Pub. Date: May 16, 2024

(54) ILLUMINATION DEVICE OF REFLECTION TYPE FOURIER PTYCHOGRAPHIC MICROSCOPY AND CONTROL METHOD THEREOF

(71) Applicant: Electronics and Telecommunications Research Institute, Daejeon (KR)

(72) Inventors: Yongjun LIM, Daejeon (KR); Kwan-Jung OH, Daejeon (KR)

(73) Assignee: Electronics and Telecommunications Research Institute, Daejeon (KR)

(21) Appl. No.: 18/481,794

(22) Filed: Oct. 5, 2023

(30) Foreign Application Priority Data
Nov. 16, 2022 (KR) 10-2022-0153917
Mar. 22, 2023 (KR) 10-2023-0037498

(51) Int. Cl. G02B 21/06; G02B 21/36; H04N 23/56; H04N 23/74; H04N 23/95

(52) U.S. Cl. CPC G02B 21/06; G02B 21/361; G02B 21/367; H04N 23/56; H04N 23/74; H04N 23/95

(57) ABSTRACT

A reflection-type Fourier ptychographic microscopy (FPM), a control method of the reflection-type FPM, and a system thereof are disclosed. According to an embodiment of the present disclosure, a reflection FPM may include an objective lens; a light splitter connected to a member including the objective lens; a first illumination system including a first LED array composed of a plurality of LEDs for irradiating a first beam passing through the objective lens through the light splitter; a second illumination system including a plurality of LEDs for radiating a second beam to a measurement sample in a periphery of the objective lens, and repeatedly moving in an up and down direction based on a virtual center line penetrating the objective lens; and a camera.

### CROSS-REFERENCE TO RELATED APPLICATIONS

This application claims the benefit of earlier filing date and right of priority to Korean Application No. 10-2022-0153917, filed on Nov. 16, 2022, Korean Application No. 10-2023-0037498, filed on Mar. 22, 2023, the contents of which are all hereby incorporated by reference herein in their entirety.

### TECHNICAL FIELD

The present disclosure relates to the field of an illumination device for a microscope, and more particularly, to an illumination device of a reflection type Fourier ptychographic microscope and a method for controlling the same.

### BACKGROUND

A microscope refers to an instrument that enlarges and observes minute objects or microorganisms that cannot be observed with the naked eye. In general, a microscope may consist of an objective lens and an eyepiece. An objective lens refers to a lens that is close to an object to be observed, and generally has a short focal length and serves to create an enlarged real image of an object. The eyepiece means a magnifying glass for viewing a real image magnified by an objective lens. The magnification of the microscope may be determined as the product of the magnification of the objective lens and the magnification of the eyepiece.

As the magnification of the microscope increases, the actual image to be observed becomes darker, so a separate lighting device for irradiating the object is required.

Meanwhile, a method of performing phase retrieval using a reflection type Fourier Ptychographic Microscopy (FPM) has been devised. When using a reflection-type FPM, there is an advantage that a phase can be calculated without a reference beam in an interferometer-based digital holography microscope using a conventional laser light source.

### SUMMARY

A technical problem of the present disclosure is to provide a reflection type Fourier Ptychographic Microscopy (FPM) lighting device and a control method thereof that increase resolution without reducing a measurement area.

An technical problem of the present disclosure is to provide a reflective FPM having a plurality of light-emitting diodes (LEDs) forming a bright field and a dark field, and a method for controlling the same.

The technical problems to be achieved in the present disclosure are not limited to the technical tasks mentioned above, and other technical problems not mentioned will be clearly understood by those skilled in the art from the description below.

As an example of the present disclosure, a reflection type Fourier ptychographic microscopy (FPM) may include an objective lens; a light splitter connected to a member including the objective lens; a first illumination system including a first light emitting diode (LED) array composed of a plurality of LEDs for irradiating a first beam passing through the objective lens through the light splitter; a second illumination system including a plurality of LEDs for radiating a second beam to a measurement sample in a periphery of the objective lens, and repeatedly moving in an up and down direction based on a virtual center line penetrating the objective lens; and a camera converting beam information that passes through the optical splitter after at least one of the first beam and the second beam is reflected or scattered from the measurement sample into image information, and the first lighting system may include a first lens array composed of a plurality of lenses corresponding to each of a plurality of LEDs constituting the first LED array, and the second lighting system may be composed of N identical sub-illumination systems.

Each of the N sub-illumination systems constituting the second illumination system may include a second LED array composed of a plurality of LEDs irradiating the second beam and a second lens array composed of a plurality of lenses corresponding to each of the plurality of LEDs constituting the second LED array.

In addition, the plurality of lenses constituting the first lens array may include a first lens and a second lens, the first lighting system may include a first member and a second member. Among the plurality of LEDs constituting the first lens and the first LED array, a first LED corresponding to the first lens may be disposed inside the first member, and among the plurality of LEDs constituting the second lens and the first LED array, a second LED corresponding to the second lens may be disposed inside the second member.

In addition, the plurality of lenses constituting the second lens array may include a third lens and a fourth lens, and the second lighting system may include a third member and a fourth member. Among the plurality of LEDs constituting the third lens and the second LED array, a third LED corresponding to the third lens may be disposed inside the third member. Among the plurality of LEDs constituting the fourth lens and the second LED array, a fourth LED corresponding to the fourth lens may be disposed inside the fourth member.

In addition, each of the first member, the second member, the third member, and the fourth member may be a cylindrical member.

In addition, the first lighting system may be composed of M identical sub-illumination systems, and the M sub-illumination systems constituting the first illumination system may have a symmetrical structure.

In addition, the N identical sub-illumination systems constituting the second illumination system may include a first sub lighting system, a second sub lighting system and a third sub lighting system connected to the first sub lighting system, and a fourth sub lighting system facing the first sub lighting system.

In addition, the reflection FPM may include at least one processor. The at least one processor may be configured to identify image information having a highest resolution among image information converted by the camera, and identify a height of the second illumination system corresponding to the identified image information.

Another example of the present disclosure, a method for controlling a reflection type Fourier ptychographic microscopy (FPM) including a first illumination system and a second illumination system may include controlling the first illumination system including a first LED array composed of a plurality of light emitting diodes (LEDs) to irradiate a first beam passing through an objective lens through a light splitter; radiating a second beam to a measurement sample from a periphery of the objective lens, and controlling the second illumination system to repeatedly move in an up and down direction based on a virtual center line penetrating the objective lens; and converting beam information passing through the optical splitter in which at least one of the first beam and the second beam is reflected or scattered from the measurement sample into image information, and the first lighting system may include a first lens array composed of a plurality of lenses corresponding to each of a plurality of LEDs constituting the first LED array, and the second lighting system may be composed of N identical sub-illumination systems.

Another example of the present disclosure, a system may include a reflection type Fourier ptychographic microscopy (FPM) including a first illumination system and a second illumination system and an electronic device connected to the reflection type FPM. The reflection FPM may be configured to: control the first illumination system including a first LED array composed of a plurality of light emitting diodes (LEDs) to irradiate a first beam passing through an objective lens through a light splitter; radiate a second beam to a measurement sample from a periphery of the objective lens, and controlling the second illumination system to repeatedly move in an up and down direction based on a virtual center line penetrating the objective lens; and convert beam information passing through the optical splitter in which at least one of the first beam and the second beam is reflected or scattered from the measurement sample into image information. In addition, the electronic device may be configured to: generate a phase image by applying a Fourier typography algorithm to the image information. The first lighting system may include a first lens array composed of a plurality of lenses corresponding to each of a plurality of LEDs constituting the first LED array, and the second lighting system may be composed of N identical sub-illumination systems.

The features briefly summarized above with respect to the disclosure are merely exemplary aspects of the detailed description of the disclosure that follows, and do not limit the scope of the disclosure.

According to various embodiments of the present disclosure, the technical problem of the present disclosure is to provide a reflective FPM lighting device and a control method thereof that increase resolution without reducing a measurement area.

According to various embodiments of the present disclosure, a reflective FPM having a plurality of light-emitting diodes (LEDs) forming a bright field and a dark field and a control method thereof may be provided.

According to various embodiments of the present disclosure, the smallest measurable magnitude value may be reduced by increasing a numerical aperture (NA) of the illumination light through configuration of the illumination light.

According to various embodiments of the present disclosure, each lighting system constituting the reflective FPM can be easily mass-produced through a symmetrical structure of the sub-illumination system.

According to various embodiments of the present disclosure, defect detection and shape measurement can be performed without damaging a sample in the semiconductor business and (micro) display industry.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings included as part of the detailed description to facilitate understanding of the present disclosure provide embodiments of the present disclosure and describe technical features of the present disclosure along with detailed descriptions.

FIG. 1 illustrates a structural diagram of a reflective FPM optical system applicable to the present disclosure.

FIG. 2 illustrates correlation distributions of brightfield, darkfield, and objective lenses in the spatial frequency domain.

FIG. 3A, FIG. 3B, and FIG. 3C illustrate a relationship diagram of the overlapping area of the spectrum distribution due to the movement of the wave number component of the LED light source for illumination.

FIG. 4 is a diagram for describing configurations of an illumination system and an optical system of the reflective FPM shown in FIG. 1.

FIG. 5 illustrates the main variables and interrelationships of the objective lens for determining the minimum incident angle of the LED light source for illumination.

FIG. 6 is a diagram for describing Equations 3 to 5 for determining the spatial arrangement of the LED light source for illumination.

FIG. 7A and FIG. 7B are an example implemented by transferring a plurality of LEDs applicable to the present disclosure onto an XY plane.

FIG. 8 is a flowchart illustrating a method of controlling a reflective FPM according to an embodiment of the present disclosure.

FIG. 9 is a diagram for describing the structure and arrangement of an illumination system 2 of a reflective FPM that can be applied to the present disclosure.

FIG. 10 illustrates a design diagram of an illumination system 1 of a reflective FPM that can be applied to the present disclosure.

FIGS. 11 and 12 are diagrams for describing the structure and arrangement of the illumination system 2 of the reflective FPM that can be applied to the present disclosure.

FIGS. 13 and 14 are diagrams for describing the structure of an illumination system 1 of a reflective FPM that can be applied to the present disclosure.

FIGS. 15 and 16 are diagrams for describing the structure of an illumination system 2 of a reflective FPM that can be applied to the present disclosure.

FIG. 17 is a diagram for describing the arrangement and structure of LEDs and lenses according to an embodiment of the present disclosure.

FIG. 18 is a diagram for describing the structure of a reflective FPM according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

A system and/or method/device (hereinafter simply referred to as ‘system’) proposed in the present disclosure relates to a reflective FPM lighting device that increases resolution without reducing a measurement area.

Specifically, the present disclosure relates to a system for performing phase measurement and resolution enhancement of a measurement sample from a photographed image acquired using a reflective FPM optical system. The diffraction limit of an optical microscope can be overcome by applying various arithmetic algorithms to single or multiple acquired image data.

That is, the present disclosure relates to a technique for increasing the resolution of an image obtained by an optical objective lens and a camera without reducing a field of view (FOV) and discloses a system for obtaining information about a three-dimensional shape structure based on a phase image.

Meanwhile, in order to increase the resolution of the microscope, a high-magnification objective lens having a high numerical aperture (NA) should be applied. This inevitably leads to a decrease in the measurement area, and the distance between the plane on which the sample is located and the objective lens is narrowed. However, through the calculation process applied to FPM, it is possible to simultaneously achieve high resolution and wide measurement range from a low-magnification objective lens with a low NA, and the advantage of ensuring sufficient distance between the sample plane and the objective lens can be utilized. It is possible to measure a high resolution area through a lighting device using an array of LED light sources without applying an expensive laser light source. Unlike the conventional transmissive FPM device, in the reflective FPM device structure, the technology of designing the lighting system according to the array of LEDs can be said to be the most central.

A Rayleigh relationship according to a numerical aperture (NA) of an objective lens and a wavelength of an illumination source may represent a limit for the smallest size that can be measured from an objective lens, that is, a diffraction limit.

The smallest size that can be measured from the objective lens can be calculated as ‘0.61*λ/NA’. The total NA value (i.e., NA_TOTAL) of the reflective FPM may be determined as the sum of the NA value of the objective lens (i.e., NA_objective lens) and the NA value of the illumination system (i.e., NA_illumination system).

Here, the reflective FPM utilization method according to the present disclosure relates to a method of overcoming the diffraction limit of the objective lens, not a technique of illuminating in the direction of the back focal plane of the objective lens. That is, the present disclosure proposes a method of increasing the NA of an objective lens through a configuration of illumination light (or light source) (e.g., light emitting diode (LED)) and ultimately reducing the smallest measurable size.

Here, the light source may be configured to uniformly irradiate the surface of the sample. In addition, the light source may be configured such that the overlapping area of the spectral components of each light source in the Fourier domain exceeds a predetermined ratio (e.g., 40%).

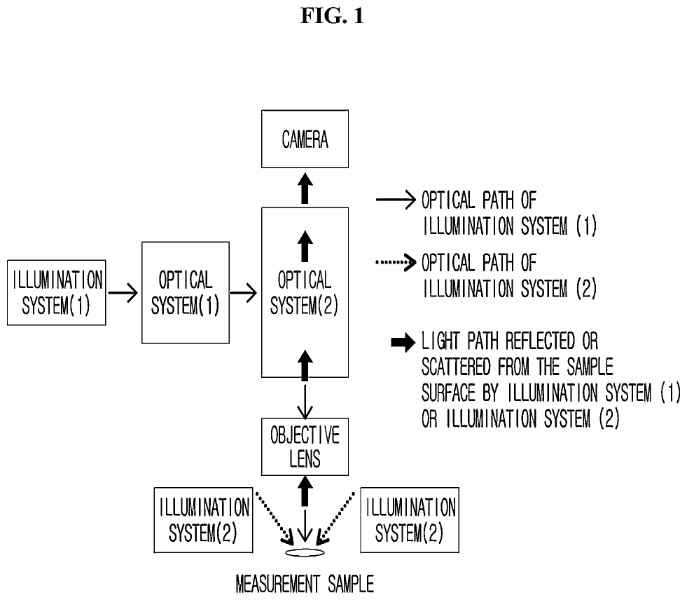

FIG. 1 illustrates a structural diagram of a reflective FPM optical system applicable to the present disclosure.

As shown in FIG. 1, the reflective FPM optical system device may include an illumination system (1), an illumination system (2), an optical system (1), an optical system (2), an objective lens, and a camera.

The illumination system may be configured by regularly arranging and disposing one or more LEDs. The illumination system may be configured in consideration of the transmission/reflection characteristics of the measurement sample and the NA of the objective lens.

That is, the size and position of one or more LEDs may be determined based on the spectrum distribution in the spatial frequency domain, and may be arranged in a specific direction to irradiate the surface of the measurement sample.

As described above, the illumination system may include one or more LEDs, but is not limited thereto. That is, the types of light sources constituting the illumination system may be implemented in various ways.

The illumination system (1) constituting the illumination system may form bright field illumination. Light irradiated through the illumination system may be focused through the optical system (1), the optical system (2), and an objective lens, and the focused light may illuminate the surface of the measurement sample. Here, the brightfield illumination may mean illumination that illuminates the sample surface with the NA of the objective lens as the center.

The illumination system (2) constituting the illumination system may form dark field illumination. Here, the dark field illumination may mean illumination that deviates from the center of the NA of the objective lens and does not pass through the objective lens.

The optical system (1) constituting the optical system may transfer the (LED) light source of the illumination system (1) to the optical system (2). That is, the optical system (1) may function so that the light of the illumination system (1) may be focused on the surface of the measurement sample by the objective lens.

The optical system (2) constituting the optical system may transmit the light source transmitted through the optical system (1) to the objective lens. The optical system (2) may serve to send light signals reflected or scattered from the surface of the measurement sample by the illumination system (1) and the light sources of the illumination system (2) back to the camera.

The objective lens may focus the bright field illumination onto the sample surface. The objective lens may receive light signal information of the measurement sample formed by the dark field illumination of the illumination system (2) and the bright field illumination of the illumination system (1) as much as the NA value and transmit the light to the optical system (2).

The camera may convert optical signal information received from a specific region of the measurement sample, the objective lens, and the optical system (2) into image information.

The brightfield illumination system (1) and the darkfield illumination system (2) by the NA of the objective lens and the distribution/arrangement of the LEDs may have a correlation with each other. Specifically, the measurement sample image resolution (or image resolution) may be calculated by ‘0.61*λ/NA’.

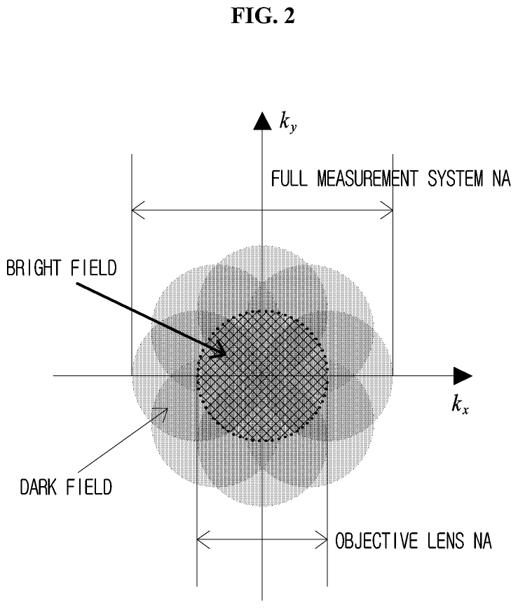

And, as shown in FIG. 2, the NA of the entire measurement system (that is, the total NA value of the reflective FPM) may be calculated by ‘NA by dark field illumination+NA by bright field illumination (or ‘NA of objective lens’)’.

Table 1 shows an example of the image resolution (i.e., the line width of the smallest measurable sample) according to the NA of the entire measurement system.

TABLE 1

| Full measurement | image |
|---|---|
| system NA | resolution (μm) |
| 0.2 | 1.616 |
| 0.3 | 1.077 |
| 0.5 | 0.646 |

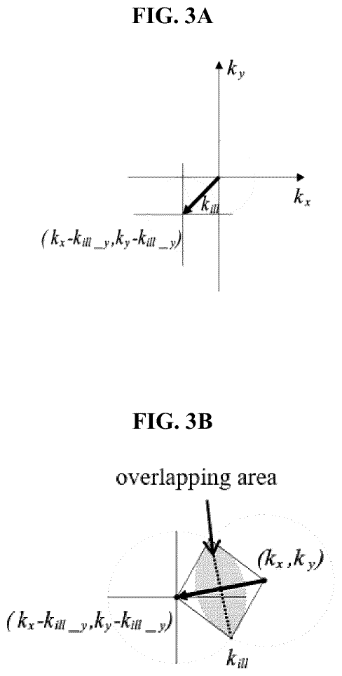

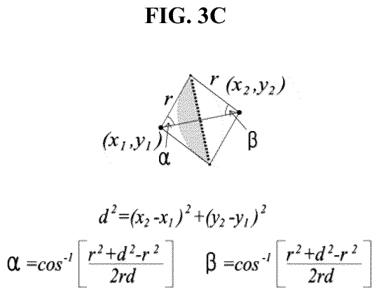

As an example, assuming that the wavelength size of the light emitted from the LEDs located in the illumination system (1) and the illumination system (2) is 530 nm, in order to measure a sample with a size of 1 μm or less, the illumination system (1) and the illumination system (2) must be configured so that the NA of the entire measurement system is 0.33 or less. To this end, the design of the incident angle of the LED light source may be obtained from a relational diagram of an overlapping region of a spectrum distribution according to a movement of a wavelength component of the LED light source in a frequency space. In FIG. 3A to 3C, the wave number of the incident angle LED illumination source is defined as k_ill.

Specifically, as shown in FIG. 3A, the wave number component of the LED light source for illumination may move. As shown in FIG. 3B, an overlapping region of spectrum distribution may occur according to the movement of the wavenumber component of the lighting LED light source. FIG. 3C shows a formula for calculating the overlapping area of the spectrum distribution.

The area of the overlapping region of the spectrum distribution may be calculated by Equation 1, and the ratio of the overlapping region can be calculated by Equation 2.

$$2 ( π {r}^{2} \frac{2 α}{2 π} - \frac{{r}^{2} sin 2 α}{2} ) \qquad [ Equation 1 ]$$

$$\frac{A}{π {r}^{2}} 100 ( \% ) \qquad [ Equation 2 ]$$

FIG. 4 is a diagram for describing configurations of an illumination system and an optical system of the reflective FPM shown in FIG. 1.

A region on a spatial spectrum by an NA may be formed based on an optical system composed of one or more optical lenses. That is, a spectrum distribution to which a target resolution (e.g., 1 μm) may be applied may be generated by the optical system. In addition, for a spectrum distribution filled by the illumination system (2), which cannot be measured through the NA of the objective lens, the image sensor may provide a light receiving function.

The two optical lenses constituting the optical system (1) shown in FIG. 4 may be designed based on the 4-f system. That is, the optical system (1) may be designed so that the LED light source forms an image on the rear focal plane of the objective lens. In addition, the optical system (1) may be designed so that the spectral region corresponding to the objective lens NA may be filled with the spectrum by the LEDs arranged in the illumination system (1).

The optical system (2) may include a beam splitter and an optical lens (e.g., a tube lens). The optical system (2) may transmit light/image information about the measurement sample received through the objective lens to the image sensor surface of the camera.

The objective lens may acquire (i.e., receive light) light information reflected or scattered from the surface of the sample to be measured by the illumination system (1) and the illumination system (2). The objective lens may function to allow received light (or beam) information to reach the image sensor surface of the camera through the optical system (2).

The working distance (WD) and NA of the objective lens are key variables in the design of the reflective FPM. The NA of the objective lens may be a criterion for distinguishing between the bright field of the illumination system (1) and the dark field of the illumination system (2).

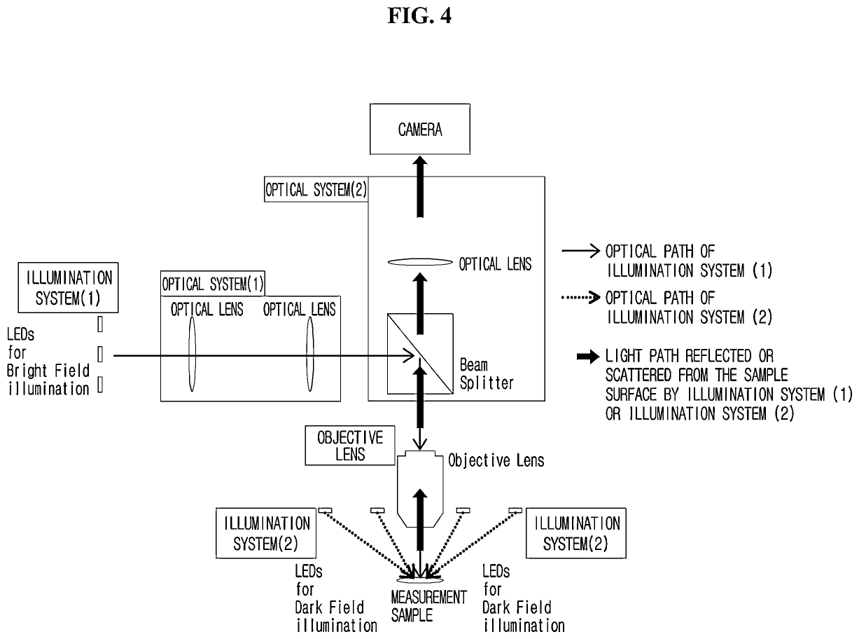

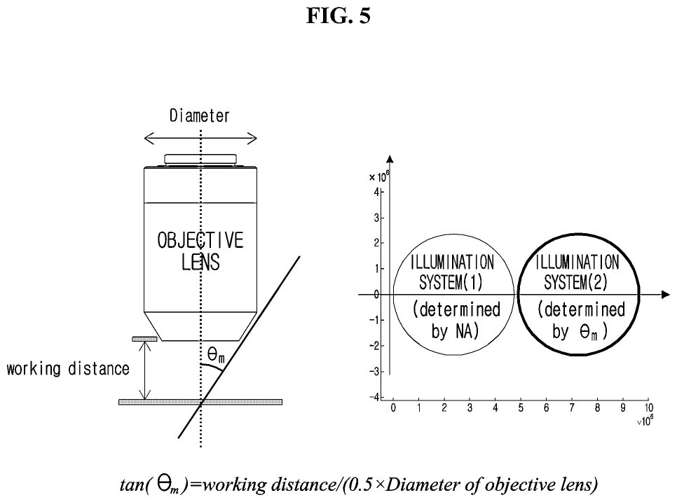

For example, as shown in FIG. 5, the minimum incident angle Om of the LED light source for illumination may be determined according to the WD of the objective lens and the diameter of the objective lens.

The camera may obtain image information through an image sensor (e.g., a charge coupled device (CCD) and a complementary metal-oxide semiconductor (CMOS)).

In order to determine the performance of the camera, it may be necessary to determine the number of pixels, the pixel size, and the pixel interval in consideration of a measurement area of a measurement sample, a minimum measurement line width, or a maximum resolution.

For example, the size of the camera's smallest pixel may be calculated as ‘objective lens magnification *λ/(2*NA)’, and the measurement area (A, maximum of FOV) may be calculated as ‘number of horizontal pixels*number of vertical pixels*(unit pixel size/system magnification)²’.

Image information obtained from a camera may be stored in a separate electronic device (e.g., a personal computer (PC), etc.) through a cable or the like. A phase image may be generated by applying an algorithm related to Fourier ptychography to image information. For example, the electronic device may generate a phase image by applying a Fourier ptychography algorithm to image information received from a reflective FPM (i.e., a camera).

A system according to an embodiment of the present disclosure may be implemented through sequential operations of an illumination system and a camera. A system according to an embodiment of the present disclosure may generate phase information through sequential combination of spectral signals on a Fourier plane.

That is, a phase image may be generated through sequential seam processes of an optical image signal transmitted to the image sensor according to the lighting of each brightfield LED by the illumination system (1) and spectral information on the frequency domain/Fourier space that is expanded according to the sequential lighting of brightfield (or darkfield) LEDs by the illumination system (2).

Accordingly, the relationship between the wave number corresponding to the incident angle of the illumination light source in space and the illumination wave number vector in the (x, y, z) direction may be derived by Equations 3 to 5 below. Here, it may be k=2π/λ.

$${k}_{x}^{2} + {k}_{y}^{2} + {k}_{z}^{2} = {k}^{2} \qquad [ Equation 3 ]$$

$${k}_{x} = k sin {θ}_{ili} cos φ , {k}_{y} = k sin {θ}_{ili} sin φ , {k}_{z} = k cos {θ}_{ili} \qquad [ Equation 4 ]$$

$${θ}_{ili} = {tan}^{- 1} \frac{\sqrt{{x}^{2} + {y}^{2}}}{h} , φ = {tan}^{- 1} \frac{y}{x} \qquad [ Equation 5 ]$$

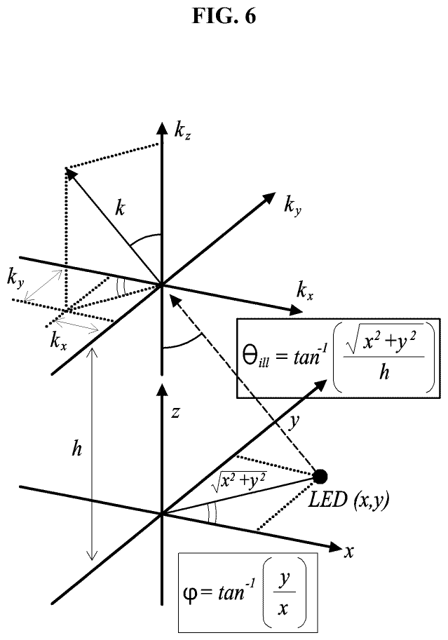

FIG. 6 is a diagram for describing Equations 3 to 5 for determining the spatial arrangement of LED light sources for lighting.

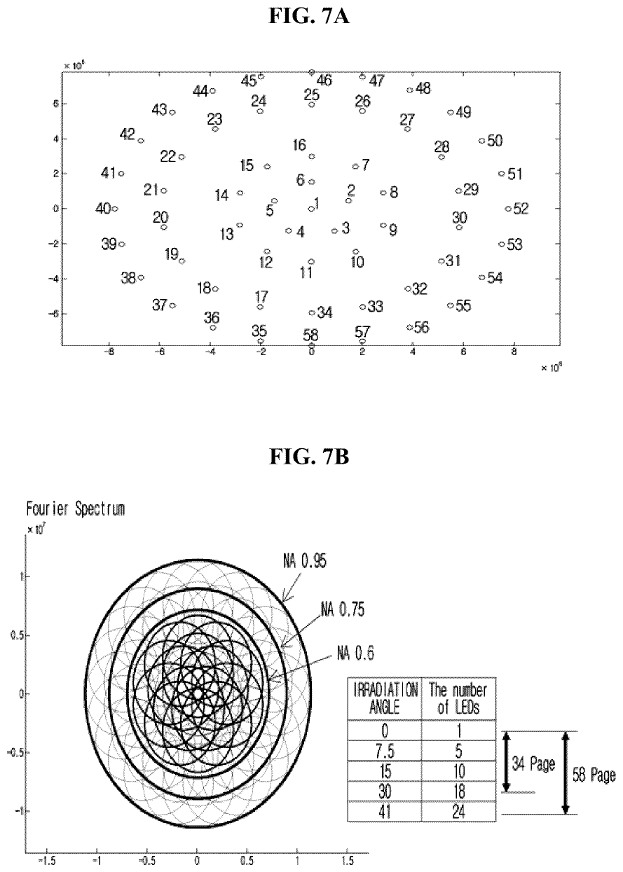

FIG. 7A and FIG. 7B are examples implemented by transferring a plurality of LEDs applicable to the present disclosure onto an XY plane.

As shown in FIG. 7A, it is assumed that 58 LEDs are arranged. For example, LEDs positioned at positions 1 to 16 may configure bright field illumination of the illumination system (1), and LEDs positioned at positions 17 to 58 may configure dark field illumination of the illumination system (2).

When the LEDs are arranged as shown in FIG. 7A, components may be configured on the Fourier spectrum.

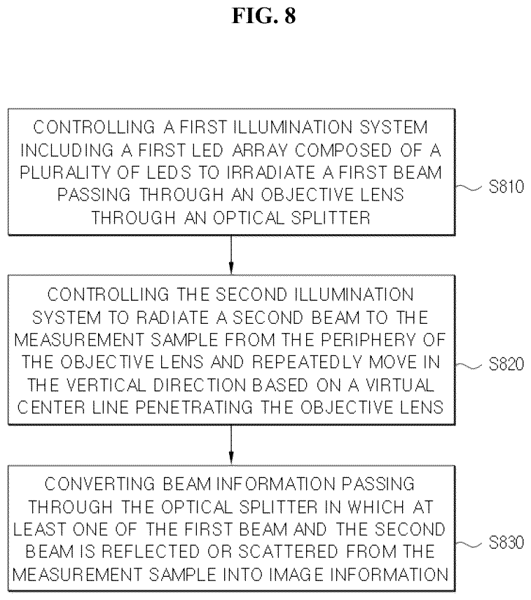

FIG. 8 is a flowchart illustrating a method of controlling a reflective FPM according to an embodiment of the present disclosure.

First, the reflective FPM shown in FIG. 8 may include an objective lens, a light splitter, a first illumination system (i.e., illumination system (1) or/and bright field illumination system), a second illumination system (i.e., illumination system (2) or/and dark field illumination system), a camera, and/or one or more processors, but is not limited thereto. One or more processors may control the first illumination system, the second illumination system, and/or the camera.

For example, one or more processors may control the first illumination system and/or the second illumination system so that LEDs included in the first illumination system and/or the second illumination system emit beams.

In addition, one or more processors may control the camera to convert beam information received through the optical splitter into image information. Specifically, the camera may convert beam information that has passed through the splitter after at least one of the first beam irradiated by the first LED array included in the first illumination system or the second beam irradiated by the second LED array included in the second illumination system is reflected or scattered from the measurement sample into image information.

One or more processors may transmit image information to an electronic device communicatively coupled to the reflective FPM. For example, the reflective FPM and the electronic device may be wired through a cable, but are not limited thereto. The reflective FPM may be communicatively connected to the electronic device wirelessly. The electronic device may generate a phase image by applying a Fourier typography algorithm to image information.

As described above, the light splitter may be connected to a member having an objective lens. Accordingly, light passing through the objective lens may be transferred to the camera through the light splitter, and light passing through the light splitter may be transferred to the objective lens.

The reflective FPM (or one or more processors included in the reflective FPM) may control a first illumination system including a first LED array composed of a plurality of LEDs to irradiate a first beam passing through an objective lens through an optical splitter (S810).

In addition, the reflective FPM may control the second illumination system to radiate a second beam to the measurement sample from the periphery of the objective lens and repeatedly move in the vertical direction based on a virtual center line penetrating the objective lens (S820).

In addition, the reflective FPM may convert beam information passing through the optical splitter in which at least one of the first beam and the second beam is reflected or scattered from the measurement sample into image information (S830).

S810 and S820 may be performed sequentially, but are not limited thereto. S810 and S820 may proceed simultaneously, or S820 may proceed before S810.

At this time, the first lighting system may include a first lens array composed of a plurality of lenses corresponding to each of a plurality of LEDs constituting the first LED array. That is, the position of each LED constituting the first LED array may correspond to the position of each lens constituting the first lens array.

Here, the number of lenses that may be included in the first lens array and the number of LED arrays that may be included in the first LED array may be determined by various values. Positions and arrangements of the lenses constituting the first lens array and the LEDs constituting the first LED array may be determined by Equations 1 to 5 according to Equation 3.

As an example of the present disclosure, the plurality of lenses constituting the first lens array may include a first lens and a second lens. The first lighting system may include a first member and a second member. Among the plurality of LEDs constituting the first lens and the first LED array, a first LED corresponding to the first lens may be disposed inside the first member. Among the plurality of LEDs constituting the second lens and the first LED array, a second LED corresponding to the second lens may be disposed inside the second member.

That is, a single lens and a single LED (i.e., a lens-LED pair) corresponding 1:1 in the first illumination system may be disposed within a specific member. Accordingly, the lens and the LED disposed on each member can generate independent spectral components without affecting each other.

Additionally or alternatively, the second illumination system may consist of N identical sub-illumination systems. That is, a single second illumination system may be configured by assembling N identical sub-illumination systems.

For example, N identical sub-illumination systems constituting the second illumination system may include a first sub lighting system, a second sub lighting system and a third sub lighting system connected to (or adjacent to) the first sub lighting system, and a fourth sub lighting system facing the first sub lighting system.

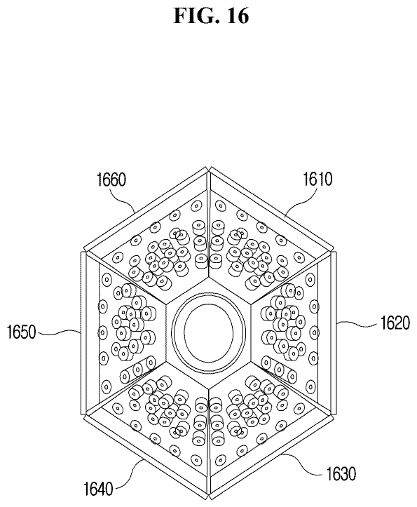

For example, as shown in FIG. 16, six sub-illumination systems may be assembled in a symmetrical structure to form one second illumination system.

And, each of the N sub-illumination systems constituting the second illumination system may include a second LED array composed of a plurality of LEDs for irradiating the second beam and a second lens array composed of a plurality of lenses corresponding to each of the plurality of LEDs constituting the second LED array.

At this time, the second illumination system may include a second lens array composed of a plurality of lenses corresponding to each of a plurality of LEDs constituting the second LED array. That is, the position of each LED constituting the second LED array may correspond to the position of each lens constituting the second lens array.

As an example of the present disclosure, the plurality of lenses constituting the second lens array may include a third lens and a fourth lens. The second illumination system may include a third member and a fourth member. At this time, a third LED corresponding to the third lens among the plurality of LEDs constituting the third lens and the second LED array may be disposed inside the third member, and among the plurality of LEDs constituting the fourth lens and the second LED array, a fourth LED corresponding to the fourth lens may be disposed inside the fourth member.

That is, a single lens and a single LED corresponding 1:1 in the second illumination system may be disposed within a specific member. Accordingly, the lens and the LED disposed on each member may generate independent spectral components without affecting each other.

Each of the above-described first member, second member, third member, and fourth member may be implemented as a cylindrical member, but is not limited thereto. Each of the first member, the second member, the third member, and the fourth member may be variously implemented to accommodate an LED and a lens pair.

Additionally or alternatively, the first illumination system may include M identical sub-illumination systems, and the M sub-illumination systems constituting the first illumination system may have a symmetrical structure.

Additionally or alternatively, one or more processors may identify image information having the highest resolution among image information converted by a camera. And, one or more processors may identify the height of the second illumination system corresponding to the identified image information.

Specifically, one or more processors may control the second illumination system to repeatedly move in a vertical direction (surrounding the objective lens) based on a virtual center line penetrating the objective lens. Accordingly, the second illumination system may radiate light toward the measurement sample from various positions (or heights relative to the ground).

At this time, one or more processors may identify image information having the highest resolution among the image information converted by the camera. In addition, one or more processors may identify the position (or height) of the second illumination system when the highest image information is acquired.

Thereafter, the one or more processors may control the second illumination system to emit light toward the measurement sample after fixing the second illumination system at the identified position (or height).

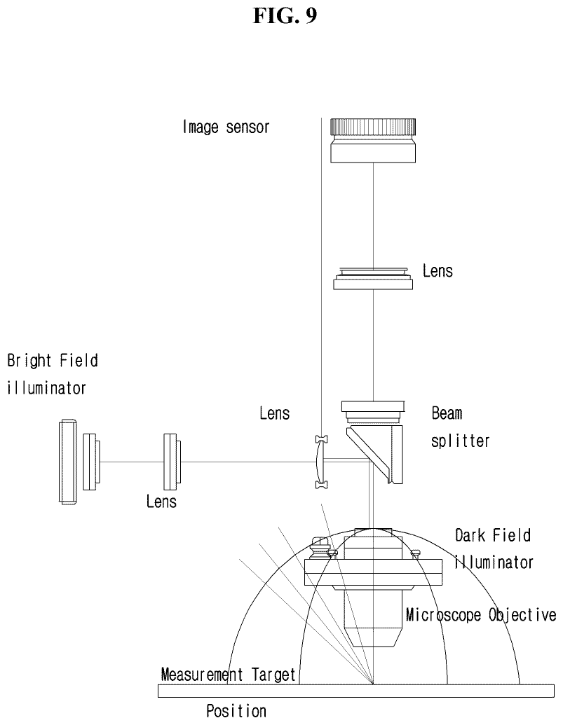

FIG. 9 is a diagram for describing the structure and arrangement of an illumination system (2) of a reflective FPM that may be applied to the present disclosure.

A 4-f optical system may be applied for brightfield (e.g., kohler illumination) illumination applied to a reflection microscope. One or more LEDs on the illumination system (2) (or dark field illuminator) may be arranged in a circle. In addition, the illumination system (2) (i.e., one or more LEDs included in the illumination system (2)) may illuminate the surface of the measurement sample while moving up and down next to the objective lens.

A structure for the spatial arrangement of one or more LEDs of the lighting system 2 may satisfy Equations 1 to 5 at the same time. When each of the images of the camera generated through the sequential lighting of the one or more LEDs is In (x, y) (n=1, 2, 3 . . . ), kₓ and k_{y} may be calculated according to the Fourier transform relationship and Equations 1 to 5. kₓ and k_{y} may be output/represented as signals in the Fourier domain or in the spectral domain.

The illumination system 2 may irradiate light to the measurement sample while moving up and down, thereby expanding a spectrum region in a frequency domain and increasing resolution.

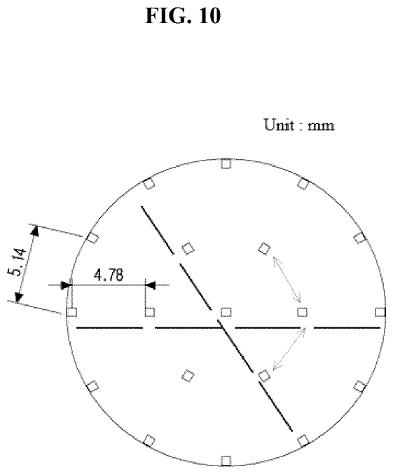

FIG. 10 illustrates a design diagram of an illumination system 1 (i.e., a bright field illumination system) of a reflective FPM that can be applied to the present disclosure. In FIG. 10, it is assumed that 19 LEDs are arranged in the lighting system (1), and the distance between each LED may be 5.14 mm or 4.78 mm.

However, this is only an example, and each LED may be arranged in the lighting system (1) in various ways.

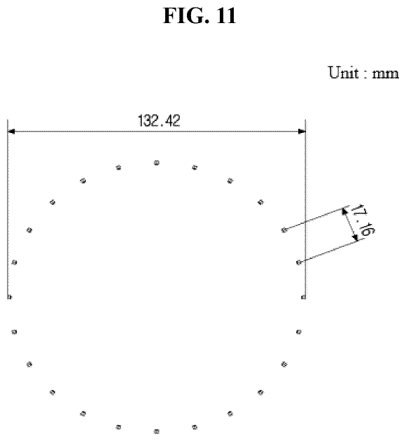

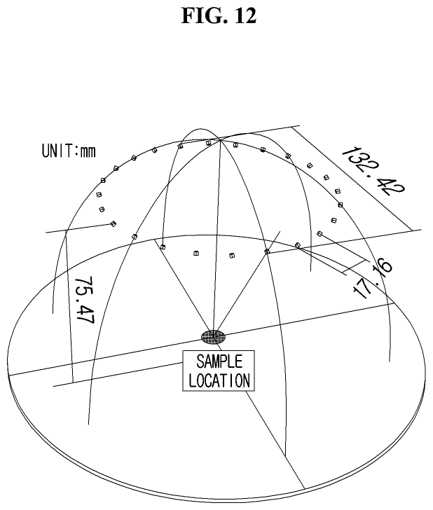

FIG. 11 and FIG. 12 are diagrams for describing the structure and arrangement of an illumination system (2) (i.e., a dark field illumination system) of a reflective FPM that may be applied to the present disclosure.

As an example, FIG. 11 shows an example of a cross-sectional view when 24 LEDs are arranged in the lighting system (2), and FIG. 12 shows how the LEDs of the lighting system (2) are arranged based on the position of the measurement sample.

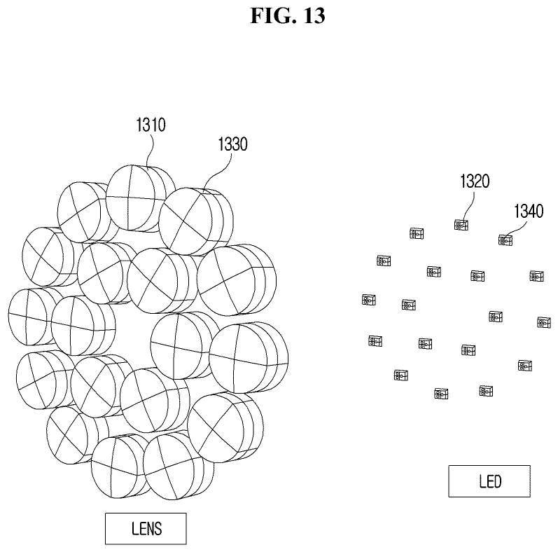

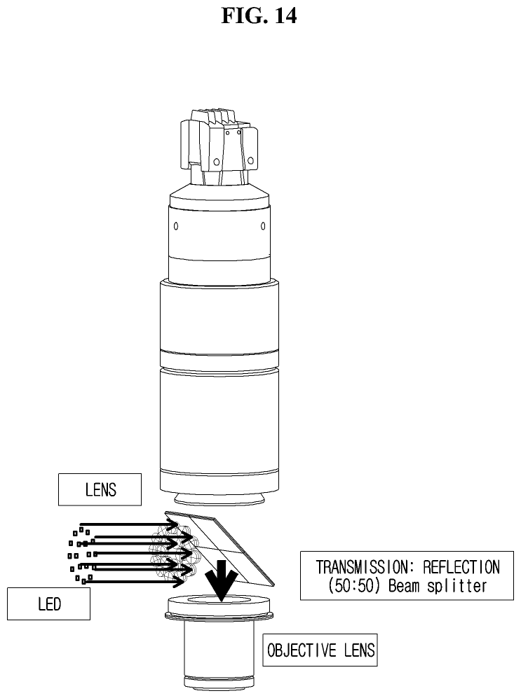

FIGS. 13 and 14 are diagrams for describing the structure of an illumination system (1) of a reflective FPM that may be applied to the present disclosure.

Each of the plurality of lenses and the plurality of LEDs included in the illumination system 1 may correspond 1:1 to each other. That is, in the illumination system 1, one lens may be arranged to correspond to one lens.

For example, as shown in FIG. 13, it is assumed that 18 lenses are disposed in the illumination system (1). At this time, 18 LEDs corresponding to each of the 18 lenses may be disposed in the lighting system (1). At this time, 18 lenses and 18 LEDs may be spaced apart by a predefined length.

For example, in the lighting system 1, the first lens 1310 and the first LED 1320 may correspond 1:1, and the second lens 1330 and the second LED 1340 may correspond 1:1.

As an example of the present disclosure, FIG. 14 assumes that the lighting system 1 is designed according to the method described in FIG. 13. Light emitted from each of the plurality of LEDs may reach each of a plurality of lenses corresponding to each of the plurality of LEDs. Light reaching the plurality of lenses may be focused on an objective lens through a transmission:reflection beam splitter.

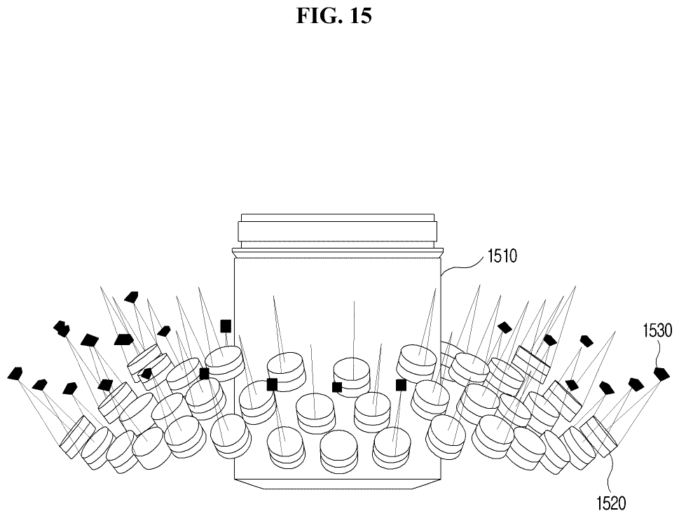

FIGS. 15 and 16 are views for describing the structure of an illumination system (2) of a reflective FPM that can be applied to the present disclosure.

As shown in FIG. 15, each of a plurality of LEDs included in the lighting system (2) may correspond to a plurality of LEDs. That is, like the relationship between the LED and the lens included in the lighting system (1) described with reference to FIGS. 13 and 14, the LED and the lens included in the lighting system (2) may also correspond 1:1.

A plurality of LEDs and a plurality of lenses constituting the illumination system (2) may be configured in such a way as to surround the objective lens 1530. A first lens 1520 of a plurality of lenses of the lighting system (1) may correspond to a first LED 1530 of a plurality of LEDs of the lighting system (1).

And, as shown in FIG. 16, the illumination system (2) may have a symmetrical structure of six pieces 1610, 1620, 1630, 1640, 1650, and 1660. That is, the illumination system (2) may be manufactured by a 6-piece planar symmetrical structure and may surround the objective lens 1530.

Specifically, each of the six pieces 1610, 1620, 1630, 1640, 1650, and 1660 constituting the illumination system (2) may include n (n is a natural number equal to or greater than 1) LEDs and n lenses. Also, each of the n LEDs may correspond to each of the n lenses.

Since each piece is configured in the same form, it is suitable for mass production, and since a finished product of the lighting system (2) may be manufactured by assembling each piece, the lighting system (2) may be easily manufactured. That is, when the lighting system (2) is composed of 6 pieces as described above, it may be easier to manufacture the lighting system (2) than when the lighting system (2) is manufactured in a ring shape or a hemispherical shape.

Additionally or alternatively, the illumination system (1) may also have a six-piece symmetrical structure. Each piece constituting the lighting system (1) may also be composed of one or more LEDs and one or more lenses corresponding to the one or more LEDs.

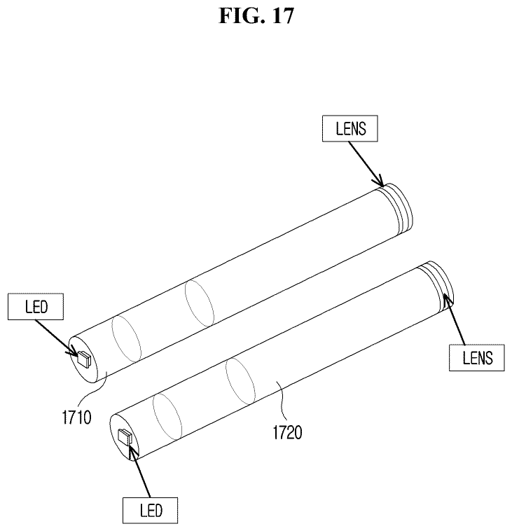

FIG. 17 is a diagram for describing the arrangement and structure of LEDs and lenses according to an embodiment of the present disclosure.

As described above, each of the illumination system (1) and/or the illumination system (2) may be composed of one or more LEDs and one or more lenses corresponding to the one or more LEDs. A single LED and a single lens corresponding to the single LED may be disposed on a member having a specific structure so that each of the one or more LEDs and the one or more lenses can generate a spectrum signal independent of each other.

For example, as shown in FIG. 17, the first LED and the first lens corresponding to the first LED may be disposed on the cylindrical first member 1710. Also, the second LED and the second lens corresponding to the second LED may be disposed on the cylindrical second member 1720. Accordingly, the spectral signals formed in each of the two members 1710 and 1720 may be independent of each other.

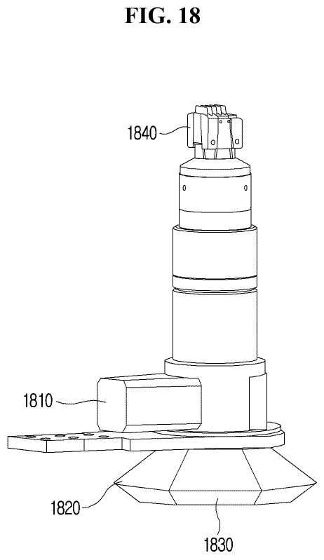

FIG. 18 is a diagram for describing the structure of a reflective FPM according to an embodiment of the present disclosure.

As mentioned above, the reflective FPM may include an illumination system (1) (i.e., bright field illumination system) 1710, an illumination system (2) (i.e., dark field illumination system) 1720, an objective lens 1730, and a camera 1740. The illumination system (1) 1710 and/or the illumination system (2) 1720 may be composed of 6 pieces having a symmetrical structure. One or more LEDs and one or more lenses included in the illumination system (1) 1710 and/or the illumination system (2) 1720 may correspond 1:1 to each other.

The illumination system (2) 1720 surrounding the objective lens 1730 may generate dark field illumination while moving up and down.

The camera 1740 may generate an image using light information reflected/scattered from the sample surface by the illumination system (1) 1710 or/and the illumination system (2) 1720.

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A reflection type Fourier ptychographic microscopy (FPM) comprising:
an objective lens;
a light splitter connected to a member including the objective lens;
a first illumination system including a first light emitting diode (LED) array composed of a plurality of LEDs for irradiating a first beam passing through the objective lens through the light splitter;
a second illumination system including a plurality of LEDs for radiating a second beam to a measurement sample in a periphery of the objective lens, and repeatedly moving in an up and down direction based on a virtual center line penetrating the objective lens; and
a camera converting beam information that passes through the optical splitter after at least one of the first beam and the second beam is reflected or scattered from the measurement sample into image information,
wherein the first lighting system includes a first lens array composed of a plurality of lenses corresponding to each of a plurality of LEDs constituting the first LED array, and
wherein the second lighting system is composed of N identical sub-illumination systems.

2. The reflection FPM of claim 1, wherein:
each of the N sub-illumination systems constituting the second illumination system includes a second LED array composed of a plurality of LEDs irradiating the second beam and a second lens array composed of a plurality of lenses corresponding to each of the plurality of LEDs constituting the second LED array.

3. The reflection FPM of claim 2, wherein:
the plurality of lenses constituting the first lens array include a first lens and a second lens,
the first lighting system includes a first member and a second member,
among the plurality of LEDs constituting the first lens and the first LED array, a first LED corresponding to the first lens is disposed inside the first member, and
among the plurality of LEDs constituting the second lens and the first LED array, a second LED corresponding to the second lens is disposed inside the second member.

4. The reflection FPM of claim 3, wherein:
the plurality of lenses constituting the second lens array include a third lens and a fourth lens,
the second lighting system includes a third member and a fourth member,
among the plurality of LEDs constituting the third lens and the second LED array, a third LED corresponding to the third lens is disposed inside the third member, and
among the plurality of LEDs constituting the fourth lens and the second LED array, a fourth LED corresponding to the fourth lens is disposed inside the fourth member.

5. The reflection FPM of claim 4, wherein:
each of the first member, the second member, the third member, and the fourth member is a cylindrical member.

6. The reflection FPM of claim 2, wherein:
the first lighting system is composed of M identical sub-illumination systems, and
the M sub-illumination systems constituting the first illumination system have a symmetrical structure.

7. The reflection FPM of claim 6, wherein:
the N identical sub-illumination systems constituting the second illumination system includes a first sub lighting system, a second sub lighting system and a third sub lighting system connected to the first sub lighting system, and a fourth sub lighting system facing the first sub lighting system.

8. The reflection FPM of claim 1, further comprising at least one processor; and
wherein the at least one processor is configured to:
identify image information having a highest resolution among image information converted by the camera, and
identify a height of the second illumination system corresponding to the identified image information.

9. A method for controlling a reflection type Fourier ptychographic microscopy (FPM) including a first illumination system and a second illumination system, the method comprising:
controlling the first illumination system including a first LED array composed of a plurality of light emitting diodes (LEDs) to irradiate a first beam passing through an objective lens through a light splitter;
radiating a second beam to a measurement sample from a periphery of the objective lens, and controlling the second illumination system to repeatedly move in an up and down direction based on a virtual center line penetrating the objective lens; and
converting beam information passing through the optical splitter in which at least one of the first beam and the second beam is reflected or scattered from the measurement sample into image information,
wherein the first lighting system includes a first lens array composed of a plurality of lenses corresponding to each of a plurality of LEDs constituting the first LED array, and
wherein the second lighting system is composed of N identical sub-illumination systems.

10. The method of claim 9, wherein:
each of the N sub-illumination systems constituting the second illumination system includes a second LED array composed of a plurality of LEDs irradiating the second beam and a second lens array composed of a plurality of lenses corresponding to each of the plurality of LEDs constituting the second LED array.

11. The method of claim 10, wherein:
the plurality of lenses constituting the first lens array include a first lens and a second lens,
the first lighting system includes a first member and a second member,
among the plurality of LEDs constituting the first lens and the first LED array, a first LED corresponding to the first lens is disposed inside the first member, and
among the plurality of LEDs constituting the second lens and the first LED array, a second LED corresponding to the second lens is disposed inside the second member.

12. The method of claim 11, wherein:
the plurality of lenses constituting the second lens array include a third lens and a fourth lens,
the second lighting system includes a third member and a fourth member,
among the plurality of LEDs constituting the third lens and the second LED array, a third LED corresponding to the third lens is disposed inside the third member, and
among the plurality of LEDs constituting the fourth lens and the second LED array, a fourth LED corresponding to the fourth lens is disposed inside the fourth member.

13. The method of claim 12, wherein:
each of the first member, the second member, the third member, and the fourth member is a cylindrical member.

14. The method of claim 10, wherein:
the first lighting system is composed of M identical sub-illumination systems, and
the M sub-illumination systems constituting the first illumination system have a symmetrical structure.

15. The method of claim 14, wherein:
the N identical sub-illumination systems constituting the second illumination system includes a first sub lighting system, a second sub lighting system and a third sub lighting system connected to the first sub lighting system, and a fourth sub lighting system facing the first sub lighting system.

16. The method of claim 9, further comprising:
identifying image information having a highest resolution among image information converted by the camera, and
identifying a height of the second illumination system corresponding to the identified image information.

17. A system including a reflection type Fourier ptychographic microscopy (FPM) including a first illumination system and a second illumination system and an electronic device connected to the reflection type FPM,
wherein the reflection FPM is configured to:
control the first illumination system including a first LED array composed of a plurality of light emitting diodes (LEDs) to irradiate a first beam passing through an objective lens through a light splitter;
radiate a second beam to a measurement sample from a periphery of the objective lens, and controlling the second illumination system to repeatedly move in an up and down direction based on a virtual center line penetrating the objective lens; and
convert beam information passing through the optical splitter in which at least one of the first beam and the second beam is reflected or scattered from the measurement sample into image information,
wherein the electronic device is configured to:
generate a phase image by applying a Fourier typography algorithm to the image information,
wherein the first lighting system includes a first lens array composed of a plurality of lenses corresponding to each of a plurality of LEDs constituting the first LED array, and
wherein the second lighting system is composed of N identical sub-illumination systems.
